(19) United States
(12) Patent Application Publication
(10) Pub. No.: US 2015/0178650 A1
(43) Pub. Date: Jun. 25, 2015

(54) ADAPTIVE CASE DESIGNING BASED ON CASE RUNTIME HISTORY

(71) Applicant: International Business Machines Corporation, Armonk, NY (US)

(72) Inventors: Srinivas Jandhyala, Hyderabad (IN); Vishnu N. Karakkattillathu Vishnu Namboothiri, Cochin (IN); Mahesh Sooryambylu, Puttur (IN)

(73) Assignee: International Business Machines Corporation, Armonk, NY (US)

(21) Appl. No.: 14/133,830

(22) Filed: Dec. 19, 2013

(51) Int. Cl. G06Q 10/06

(52) U.S. Cl. CPC G06Q 10/06313

(57) ABSTRACT

Embodiments of the present invention disclose a method, computer program product, and system for adaptively designing a case solution in a case management environment. A computer analyzes a plurality of completed cases to identify a subset of completed cases having a common, first set of attributes. The computer identifies at least one pattern in the subset of completed cases, wherein the at least one pattern comprises common decision making trends in the subset of completed cases. The computer determines that the first set of attributes in the subset of completed cases is substantially similar to a second set of attributes, wherein the second set of attributes is associated with a case solution. The computer generates a suggested modification to the case solution based, at least in part, on the at least one pattern.

### FIELD OF THE INVENTION

The present invention relates generally to the field of case management, and more particularly to adaptive case designing.

### BACKGROUND OF THE INVENTION

Case management is an alternative to traditional business process management (BPM) solutions that recognizes that some business problems require a great deal of flexibility, adaptability, control, or collaboration and are, therefore, not amenable to more heavily structured BPM solutions. Case management revolves around the processing of a case, a collection of information and coordinated activities or tasks, by case workers. Business analysts design a case solution using a case design tool or case designer. A business analyst defines case attributes, such as case properties (e.g., identifying information about the case), tasks to be completed by case workers, and documents to be uploaded to the active case. The business analyst then deploys the case solution to a case runtime to create an active case. Case workers access the documents and complete the tasks in the case runtime in order to implement the case solution. Case workers also sometimes add ad-hoc tasks to the case solution.

Case management applications typically contain at least two components: The case designer and the case runtime. In the case designer, one or more business analysts create the case solution by uploading documents to the case folder and assigning tasks to be completed by the case workers. In the case runtime, case workers access and process active cases. The case runtime also includes an associated case history in which events affecting the case, such as the modification, addition, or completion of tasks, the addition of documents, and the modification/addition of case properties, are stored.

### SUMMARY

Embodiments of the present invention disclose a method, computer program product, and system for adaptively designing a case solution in a case management environment. A computer processor analyzes a plurality of completed cases to identify a subset of completed cases having a common, first set of attributes. The computer processor identifies at least one pattern in the subset of completed cases, wherein the at least one pattern comprises common decision making trends in the subset of completed cases. The computer processor determines that the first set of attributes in the subset of completed cases is substantially similar to a second set of attributes, wherein the second set of case attributes is associated with a case solution. The computer generates a suggested modification to the case solution based, at least in part, on the at least one pattern.

### BRIEF DESCRIPTION OF THE SEVERAL VIEWS OF THE DRAWINGS

FIG. 1 is a functional block diagram illustrating a case management environment, in accordance with an embodiment of the present invention.

FIG. 2 is a flowchart depicting operational steps of a case suggestion program operating in the case management environment of FIG. 1 for providing business analysts with case solution update suggestions, in accordance with an embodiment of the present invention.

FIG. 3 depicts a block diagram of components of a computer executing the case suggestion program of FIG. 2, in accordance with an embodiment of the present invention.

### DETAILED DESCRIPTION

Embodiments of the present invention recognize that after a business analyst develops a case solution in the case designer and deploys the case solution to the case runtime to create an active case, some business analysts wish to reexamine the case solution and determine whether there are aspects of the solution that can be improved.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by, or in connection with, an instruction execution system, apparatus, or device.

A computer-readable signal medium may include a propagated data signal with computer-readable program code embodied therein, for example, in baseband or as part of a carrier wave. Such a propagated signal may take any of a variety of forms including, but not limited to, electro-magnetic, optical, or any suitable combination thereof. A computer-readable signal medium may be any computer-readable medium that is not a computer-readable storage medium and that can communicate, propagate, or transport a program for use by, or in connection with, an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java®, Smalltalk®, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer-implemented process such that the instructions which execute on the computer or other programmable apparatus provide processes for implementing the functions/acts specified in the flowchart and/or block diagram block or blocks.

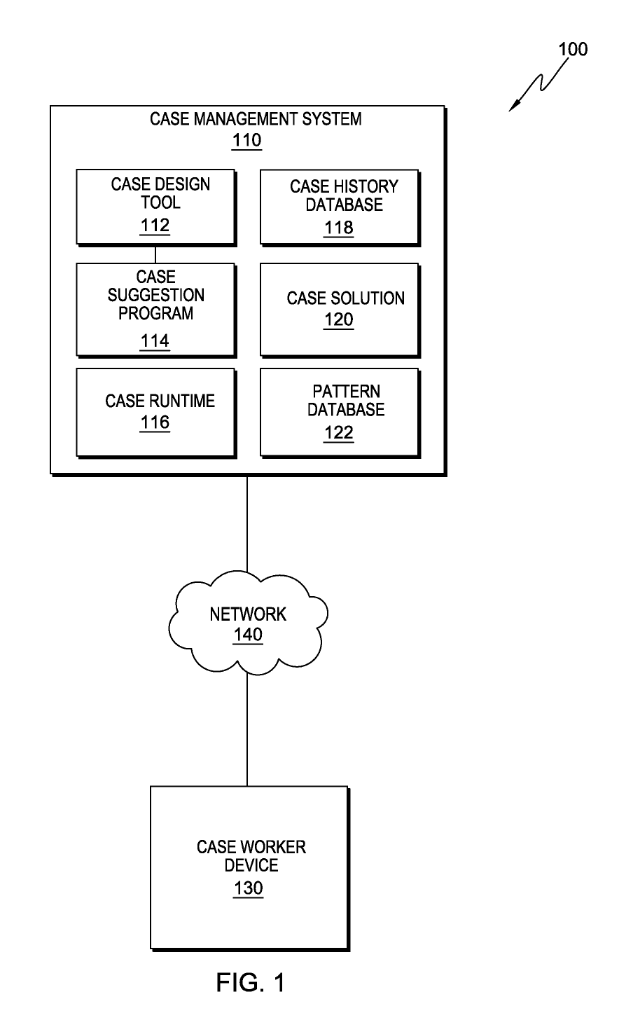

The present invention will now be described in detail with reference to the Figures. FIG. 1 is a functional block diagram illustrating a case management environment, generally designated 100, in accordance with an embodiment of the present invention.

Case management environment 100 includes case management system 110 and case worker device 130 interconnected via network 140. In this embodiment, case management system 110 includes case design tool 112, case suggestion program 114, case runtime 116, case history database 118, case solution 120, and pattern database 122.

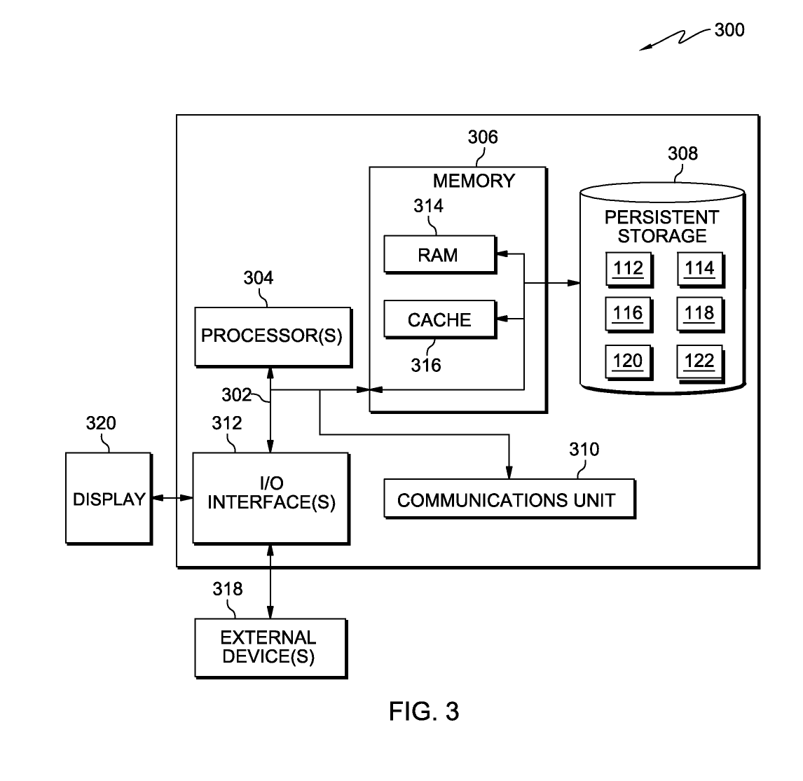

In various embodiments of the present invention, case management system 110 can be a server, a laptop computer, a tablet computer, a netbook computer, a personal computer (PC), or a desktop computer. In another embodiment, case management system 110 represents a computing system utilizing clustered computers and components to act as a single pool of seamless resources. In general, case management system 110 can be any computing device or a combination of devices with access to case design tool 112, case runtime 116, case history database 118, case solution 120, and pattern database 122 and is capable of running case suggestion program 114. Case management system 110 may include internal and external hardware components, as depicted and described in further detail with respect to FIG. 3.

Case management system 110 includes case design tool 112. Case design tool 112 is an application which allows a user to create a case solution, such as case solution 120, by, for example, assigning tasks to case workers, uploading documents to the case solution, and/or allowing a user to review the status of a case. In one embodiment, case design tool 112 includes a graphical user interface (GUI) which allows one or more business analysts to define a set of tasks to be performed by case workers in order to implement a case solution to a business problem. Business analysts also use case design tool 112 to edit existing case solutions based on, for example, changing business circumstances, case worker feedback, and/or case solution goals. In order to edit existing cases, the business analyst opens case design tool 112 into a case solution editing session in which he can make the desired modifications to the case solution by interacting with the GUI of case design tool 112.

Case management system 110 includes case suggestion program 114. Case suggestion program 114 analyzes case histories in order to identify patterns in previous cases with respect to the timing and circumstances under which particular decisions were made. Case suggestion program 114 stores the identified patterns in a pattern database, such as pattern database 122. Case suggestion program 114 monitors the case solution editing session of case design tool 112 to identify attributes of the case solution being created or modified with case design tool 112. Based on the case solution editing session and attributes of the case solution being created or modified in case design tool 112, case suggestion program 114 provides the user, e.g., a business analyst, with case suggestions, such as suggested tasks, modifications, or decisions to implement in the case solution. In another embodiment, case suggestion program 114 provides suggestions from an external system, such as a website, in order to supplement suggestions with additional information. For example, case suggestion program 114 accesses an external website over the internet in order to access industry standards and best practices for the field in which case solution 120 is applicable and then provides case suggestions to the user based on this information.

Case management system 110 includes case runtime 116. Case runtime 116 allows case workers to access an active case in order to complete tasks associated with the active case, upload documents, and/or create ad-hoc tasks. In one embodiment, case runtime 116 includes a GUI which allows case workers to enter changes to the active case, record the completion of tasks, and/or upload documents associated with the active case. In one embodiment, case runtime 116 includes an associate case history, such as case history database 118. In one embodiment, case history database 118 includes historical information regarding one or more completed cases, such as case properties, the status of the case at the time certain decisions regarding the case solution were made, and/or documents and attachments made to the past cases. Completed cases are cases that the case workers and/or business analysts have deemed to have a completely implemented case solution. Once a case is complete it is stored in case history database along with all of the data associated with the case including case attributes, case properties, and/or case tasks. In one embodiment, case history database 118 is a database containing the historical information about past cases. In this embodiment, the database may either be an internal database included in case management system 110 or an external database server connected to case management system 110 via network 140. The historical information stored in case history database 118 includes detailed information about each step taken by case workers and/or business analysts while processing the case, including ad-hoc tasks created by case workers.

Case worker device 130 is a computing system that a user, such as a case worker, may use to access data stored on case management system 110 via network 140. For example, case worker device 130 can access and display the active case information stored in case runtime 116 as well as complete tasks associated with the active case. In various embodiments, case worker device 130 can be a server, a laptop computer, a tablet computer, a netbook computer, a personal computer (PC), or a desktop computer. In another embodiment, case worker device 130 represents a computing system utilizing clustered computers and components to act as a single pool of seamless resources. In general, case worker device 130 can be any computing device, or a combination of devices, with access to case runtime 116. Case worker device 130 may include internal and external hardware components, as depicted and described in further detail with respect to FIG. 3.

Network 140 can be, for example, a local area network (LAN), a wide area network (WAN) such as the Internet, or a combination of the two, and can include wired, wireless, or fiber optic connections. In general, network 140 can be any combination of connections and protocols that will support communications between case management system 110 and client device 130.

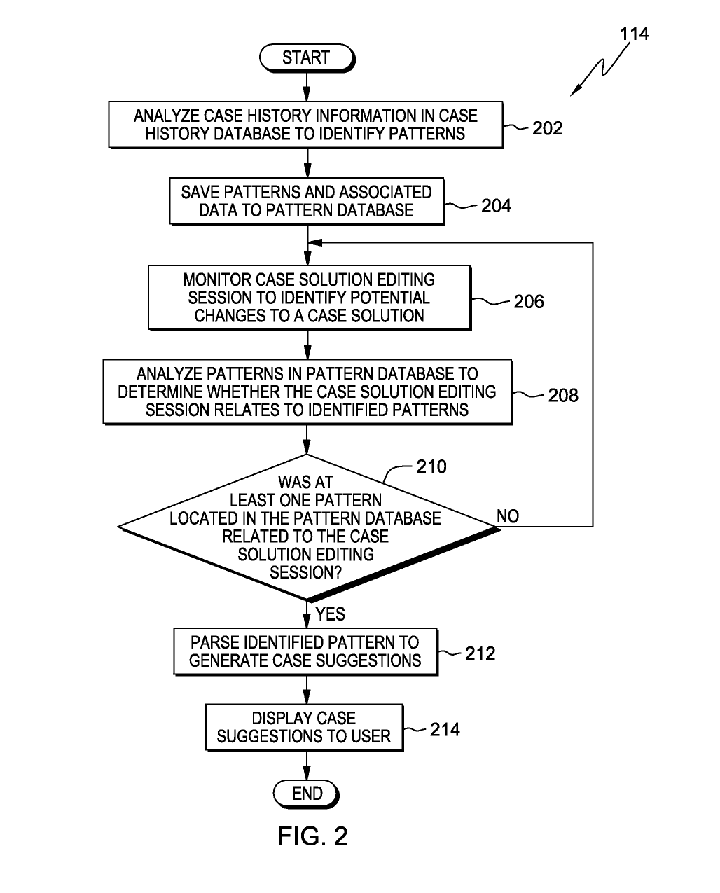

FIG. 2 is a flowchart depicting operational steps of case suggestion program 114 operating in the case management environment of FIG. 1, for providing business analysts with case solution update suggestions, in accordance with an embodiment of the present invention.

Case suggestion program 114 analyzes the case history information in case history database 118 to identify patterns (step 202). Case suggestion program 114 accesses data stored in case history database 118, and performs content analytics or data mining to identify decision making patterns for the cases stored in case history database 118. In one embodiment, case suggestion program 114 analyzes the data in case history database 118 to determine what the case property values were at the time a specified decision was made. The data stored in case history database includes, for example, all tasks and documents related to the cases stored therein, information regarding the time at which tasks were completed and events regarding the implementation of the case solution took place, and any other information related to the completion of the past cases. In one embodiment, case suggestion program 114 compares attributes of case solution 120 to attributes of completed cases stored in case history database 118 to identify a subset of completed cases that share at least one attribute in common with case solution 120. For example, if case solution 120 happens to be in the field of consumer complaints, then case suggestion program 114 runs a search in case history database for completed cases that were also directed to the field of consumer complaints. Then, case suggestion program 114 limits its pattern identification process (i.e. data mining) to the subset of completed cases that are in the consumer complaints field.

One example of a pattern is determining that a significant number of past cases all created a particular task when a specific property value, such as business address, changed. Case properties are used to describe and identify each case and include general information regarding the case. Case properties can be different data types such as strings, Boolean values, date/time, floating point numbers, or integers. In another embodiment, case suggestion program 114 determines what the content of certain documents entailed at the time a specified decision was made. Documents can be, for example, correspondence regarding the business problem sought to be solved, or specific forms related to the business, such as complaint forms, invoice forms, or other business documents. In one embodiment, case suggestion program 114 performs the analysis in real time as a case worker or business analyst makes changes to a case solution in order to identify patterns relevant to the present change. In another embodiment, case suggestion program 114 performs the analysis prior to any changes being made to a case solution for use later in the processing of a case. The analysis can be performed using existing data mining or content analytic techniques such as association rule learning, anomaly/outlier/change detection, or structured text mining.

Case suggestion program 114 saves identified patterns and any associated data to pattern database 122 (step 204). Case suggestion program 114 saves each pattern it identifies, as well as any associated data (e.g., case properties, documents, and attachments), to a designated pattern database, such as pattern database 122. In one embodiment, pattern database 122 is stored on a persistent memory device such as an external server, random access memory (RAM), or cache memory. In another embodiment, pattern database 122 is a text file that includes all of the information regarding the identified pattern such as the case properties, document contents, and/or attachments to the case.

Case suggestion program 114 monitors the case solution editing session to identify potential changes to a case solution (step 206). Case suggestion program 114 monitors, in real time or near real time, actions taken that affect case solution 120 in order to identify the state of the case and to identify changes that case workers and/or business analysts may be making. Case suggestion program 114 receives information from case design tool 112 regarding the editing session of case solution 120 such as the case properties, documents attached to the case, the content of attachments to the case, and/or the state of assigned tasks in the case.

Case suggestion program 114 analyzes the patterns stored in pattern database 122 to determine whether information in the case solution editing session relates to identified patterns stored in pattern database 122 (step 208). Case suggestion program 114 compares data received as a result of monitoring the case solution editing session with data stored in pattern database 122 in order to determine if any patterns in pattern database 122 are similar to the current state of case solution 120. In one embodiment, case suggestion program 114 compares the properties of case solution 120 with the properties that characterize identified patterns stored in pattern database 122. In another embodiment, case suggestion program 114 compares the tasks currently assigned in case solution 120 to tasks that were assigned in past cases and determines if the cases are similar. In another embodiment, case suggestion program 114 compares tasks that are currently assigned in case solution 120 to patterns in pattern database 122 to determine if the tasks in the current case were assigned in previous cases. In this embodiment, case suggestion program 114 has the ability to both suggest tasks that are not currently part of case solution 120 and to delete tasks that were deemed unnecessary in past cases.

Case suggestion program 114 determines whether at least one pattern identified in pattern database 122 relates to the case solution editing session (decision block 210). If case suggestion program 114 determines that no patterns identified in pattern database 122 relate to the current state of the case solution being modified in case design tool 112 (decision block 210, NO branch), then case suggestion program 114 continues to monitor the case solution editing session to identify potential changes to case solution 120 in step 206. If case suggestion program 114 determines that at least one pattern was located in the pattern database that relates to case solution 120 being modified in case design tool 112 (decision block 210, YES branch), then case suggestion program 114 parses the identified pattern to generate case suggestions in step 212.

Case suggestion program 114 parses the identified pattern to generate case suggestions (step 212). In one embodiment, case suggestion program 114 compares the case properties in case solution 120 to the case properties associated with the identified pattern to determine if changes to completed case properties have historically occurred at the current state of case solution 120. In another embodiment, case suggestion program 114 determines which tasks occur in the identified pattern that are not currently assigned in case solution 120. In another embodiment, case suggestion program 114 determines which tasks are assigned in case solution 120, but have historically been removed or not performed in the identified pattern. For example, case suggestion program 114 scans the case history for tasks in completed cases that do not have a completion date associated with the task or are noted in the case history to have been deleted at some point in time during the implementation of the completed case. In one embodiment, case suggestion program 114 determines which documents and/or attachments have historically been added to completed cases that are comparable to case solution 120.

Case suggestion program 114 displays the case suggestions to the user (step 214). Case suggestion program 114 provides real time feedback and suggestions to the user that is currently working on case solution 120 by displaying the suggestions generated in step 212 to that user. For example, if case suggestion program 114 locates a pattern stored in pattern database 122 that indicates that, historically, cases similar to case solution 120 had a particular task added to the case solution, then case suggestion program 114 will provide a suggestion to the case worker or business analyst editing case solution 120 to add the task to case solution 120. In one embodiment, the suggestion is provided in a pop-up window. In another embodiment, case design tool 112 and/or case runtime 116 has a sidebar or toolbar that provides real time suggestions to users via the GUI of case design tool 112 or case runtime 116.

FIG. 3 depicts a block diagram of components of computer 300 executing case suggestion program 114, in accordance with an embodiment of the present invention. Computer 300 may represent, for example, case management system 110 or case worker device 130. It should be appreciated that FIG. 3 provides only an illustration of one implementation and does not imply any limitations with regard to the environments in which different embodiments may be implemented. Many modifications to the depicted environment may be made.

Case management system 110 and case worker device 130 include communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Case design tool 112, case suggestion program 114, case runtime 116, case history database 118, case solution 120, and pattern database 122 are stored in persistent storage 308 for execution and/or access by one or more of computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including case worker device 130 and case management system 110. In these examples, communications unit 310 includes one or more network interface cards. Communications unit 310 may provide communications through the use of either or both physical and wireless communications links. Case design tool 112, case suggestion program 114, case runtime 116, case history database 118, case solution 120, and pattern database 122 may be downloaded to persistent storage 308 through communications unit 310.

I/O interface(s) 312 allows for input and output of data with other devices that may be connected to case management system 110 and/or case worker device 130. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., case design tool 112, case suggestion program 114, case runtime 116, case history database 118, case solution 120, and pattern database 122, can be stored on such portable computer-readable storage media and can be loaded onto persistent storage 308 via I/O interface(s) 312. I/O interface(s) 312 also connect to display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience and thus, the invention should not be limited to use solely in any specific application identified and/or implied by such nomenclature.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method comprising:
analyzing, by one or more computer processors, a plurality of completed cases to identify a subset of completed cases having a common, first set of attributes;
identifying, by one or more computer processors, at least one pattern in the subset of completed cases, wherein the at least one pattern comprises common decision making trends in the subset of completed cases;
determining, by one or more computer processors, that the first set of attributes in the subset of completed cases is substantially similar to a second set of attributes, wherein the second set of attributes is associated with a case solution; and
generating a suggested modification to the case solution based, at least in part, on the at least one pattern.

2. The method of claim 1, wherein the subset of completed cases includes completed cases having at least one attribute that is substantially similar to at least one attribute associated with the case solution.

3. The method of claim 1, wherein the suggested modification is displayed to a user of the one or more computer processors.

4. The method of claim 1, further comprising:
identifying, by one or more computer processors, a modification made to at least one attribute of the second set of attributes; and
updating, by one or more computer processors, the subset of completed cases to include completed cases that possess the at least one modified attribute.

5. The method of claim 4, wherein the modification is identified at substantially the same time that the modification is made.

6. The method of claim 1, further comprising:
accessing a set of best practices relevant to the case solution;
determining that the case solution does not include at least one best practice of the set of best practices; and
generating a suggested modification to the case solution based, at least in part, on at least one best practice of the set of best practices.

7. The method of claim 1, further comprising:
generating a pattern database wherein the pattern database comprises a plurality of patterns that correspond to the first set of case attributes.

8. A computer program product, the computer program product comprising:
one or more computer-readable storage media and program instructions stored on the one or more computer-readable storage media, the program instructions comprising:
program instructions to analyze, by one or more computer processors, a plurality of completed cases to identify a subset of completed cases having a common, first set of attributes;
program instructions to identify, by one or more computer processors, at least one pattern in the subset of completed cases, wherein the at least one pattern comprises common decision making trends in the subset of completed cases;
program instructions to determine, by one or more computer processors, that the first set of attributes in the subset of completed cases is substantially similar to a second set of attributes, wherein the second set of attributes is associated with a case solution; and
program instructions to generate a suggested modification to the case solution based, at least in part, on the at least one pattern.

9. The computer program product of claim 8, wherein the subset of completed cases includes completed cases having at least one attribute that is substantially similar to at least one attribute associated with the case solution.

10. The computer program product of claim 8, wherein the suggested modification is displayed to a user of the one or more computer processors.

11. The computer program product of claim 8, further comprising:
program instructions to identify, by one or more computer processors, a modification made to at least one attribute of the second set of attributes; and
program instructions to update, by one or more computer processors, the subset of completed cases to include completed cases that possess the at least one modified attribute.

12. The computer program product of claim 11, wherein the modification is identified at substantially the same time that the modification is made.

13. The computer program product of claim 8, further comprising:
program instructions to access a set of best practices relevant to the case solution;
program instructions to determine that the case solution does not include at least one best practice of the set of best practices; and
program instructions to generate a suggested modification to the case solution based, at least in part, on at least one best practice of the set of best practices.

14. The computer program product of claim 8, further comprising:
program instructions to generate a pattern database wherein the pattern database comprises a plurality of patterns that correspond to the first set of case attributes.

15. A computer system, the computer system comprising:
one or more computer processors;
one or more computer-readable storage media;
program instructions stored on the computer-readable storage media for execution by at least one of the one or more processors, the program instructions comprising:
program instructions to analyze, by one or more computer processors, a plurality of completed cases to identify a subset of completed cases having a common, first set of attributes;
program instructions to identify, by one or more computer processors, at least one pattern in the subset of completed cases, wherein the at least one pattern comprises common decision making trends in the subset of completed cases;
program instructions to determine, by one or more computer processors, that the first set of attributes in the subset of completed cases is substantially similar to a second set of attributes, wherein the second set of attributes is associated with a case solution; and
program instructions to generate a suggested modification to the case solution based, at least in part, on the at least one pattern.

16. The system of claim 15, wherein the subset of completed cases includes completed cases having at least one attribute that is substantially similar to at least one attribute associated with the case solution.

17. The system of claim 15, wherein the suggested modification is displayed to a user of the one or more computer processors.

18. The system of claim 15, further comprising:
program instructions to identify, by one or more computer processors, a modification made to at least one attribute of the second set of attributes; and
program instructions to update, by one or more computer processors, the subset of completed cases to include completed cases that possess the at least one modified attribute.

19. The system of claim 18, wherein the modification is identified at substantially the same time that the modification is made.

20. The system of claim 15, further comprising:
program instructions to access a set of best practices relevant to the case solution;
program instructions to determine that the case solution does not include at least one best practice of the set of best practices; and
program instructions to generate a suggested modification to the case solution based, at least in part, on at least one best practice of the set of best practices.
